(19) United States
(12) Patent Application Publication
(10) Pub. No.: US 2020/0166614 A1
(43) Pub. Date: May 28, 2020

(54) LASER SCANNER AND MOTOR VEHICLE COMPRISING A LASER SCANNER

(71) Applicant: VALEO Schalter und Sensoren GmbH, Bietigheim-Bissingen (DE)

(72) Inventor: Serge Tchouaffe, Bietigheim-Bissingen (DE)

(73) Assignee: VALEO Schalter und Sensoren GmbH, Bietigheim-Bissingen (DE)

(21) Appl. No.: 15/778,311

(22) PCT Filed: Oct. 26, 2016
(86) PCT No.: PCT/EP2016/075792

§ 371 Date: May 23, 2018

(30) Foreign Application Priority Data
Nov. 26, 2015 (DE) 10 2015 120 538.6

(51) Int. Cl. G01S 7/481; G01S 17/931; G01S 17/42

(52) U.S. Cl. CPC G01S 7/4817; G01S 17/42; G01S 17/931

(57) ABSTRACT

The invention relates to a laser scanner for a motor vehicle comprising an optical emitter for illuminating surroundings of the laser scanner and comprising an optoelectronic receiver for receiving light beams (11) reflected at a target object in the surroundings of the laser scanner. The laser scanner additionally comprises a control unit (27) and a deflection mirror arrangement (22), which is arranged in the region of a beam path (30) of the light beams (11) between optical emitter and optoelectronic receiver, and which is connected in a signal-transmitting manner to the control unit (27) for the step-by-step scanning of a field of vision of the laser scanner in partial fields of vision.

The invention additionally relates to a motor vehicle comprising such a laser scanner.

To reduce the production and/or operating costs of a laser scanner for motor vehicles, the deflection mirror arrangement (22) comprises multiple deflection mirrors (23, 24), which are arranged in relation to one another such that each deflection mirror (23, 24) acquires a partial field of vision (29) of the field of vision of the laser scanner. Each deflection mirror (23, 24) is designed as switchable in this case by the control unit (27) between an active mirror status (25), in which the respective deflection mirror (24) reflects incoming light beams (11) in the beam path (30), and a passive mirror status (26), in which incoming light beams (11) in the beam path (30) pass the deflection mirror.

The invention relates to a laser scanner for a motor vehicle. The invention additionally relates to a motor vehicle comprising such a laser scanner.

Laser scanners are used in motor vehicles for acquiring and ascertaining items of information about the surroundings of the vehicle for driver assistance systems, i.e., electronic auxiliary devices for assisting the driver in certain driving situations. Laser-based systems, also known under the name LIDAR (“light detection and ranging”), are used for optical distance and velocity measurement and enable the recognition of objects in the field of vision of the laser scanner.

A laser scanner operates according to the light runtime principle, wherein an optical emitter illuminates the surroundings of the laser scanner. The laser scanner comprises an optoelectronic receiver for reflected beams, i.e., those light beams which are reflected from a target object in the field of vision of the laser scanner. The optoelectronic receiver provides a corresponding electrical reception signal for analysis as a function of the received (reflected) light beams. The runtime between the emission and reception of an echo is proportional to the distance to the target object, whereby items of information about the target object in the field of vision of the laser scanner can be ascertained continuously. The laser scanner is placed, for example, in the front region of the motor vehicle, for example behind the windshield or on the radiator grill, in order to ascertain the time until impact (TTC=“time to collision”), inter alia. However, laser scanners can also be placed in the lateral region of the motor vehicle, for example, in order to monitor the blind spot of the motor vehicle.

Known laser scanners comprise a deflection mirror arrangement for the step-by-step scanning of a field of vision of the laser scanner in partial fields of vision, which is connected in a signal-transmitting manner to the control unit. DE 10 2010 047 984 A1 discloses a laser scanner comprising a laser as an optical emitter, an optoelectronic receiver, and a deflection mirror unit, which is arranged in the beam path between the optical emitter and the receiver. The deflection mirror unit of the known laser scanner guides the emitted beams using an emission mirror onto the scene to be surveyed. A reception mirror associated with the receiver guides the beams reflected from target objects onto the receiver. The emission mirror and the reception mirror are rotatable about a common axis of rotation, which is driven by a drive unit. A control unit is connected in a signal-transmitting manner to the deflection mirror arrangement, in order to associate the measurement results of the receiver step-by-step with the respective rotational angle positions of the deflection mirror arrangement. In this manner, the field of vision of the laser scanner is scanned step-by-step as the rotating deflection mirror arrangement revolves.

The power consumption and the heat production of the known laser scanner result in high operating costs in operation of the laser scanner.

A distance sensor having single surface scanning is known from DE 10 2005 049 471 B4, in which the distance is measured according to the runtime principle of light pulses. The known distance sensor comprises an emitter unit, which simulates light beams of a first wavelength using a first laser and simulates light beams of a second wavelength using a second laser. The surface to be measured is illuminated in partial surfaces by each of the two lasers of the emitter unit via a controllable mirror. A first receiving system has a detector for radiation of the first wavelength and a second receiving system has a detector for radiation of the second wavelength. The distance sensor has a mirror matrix, wherein by activating at least one of the elements of this mirror matrix to be transmissive, the illuminated partial surface is only applied to the detector of the first receiving system.

The present invention is based on the object of reducing the operating costs of a laser scanner for motor vehicles.

The object is achieved according to the invention by a laser scanner having the features of claim 1. Moreover, the object is achieved by a motor vehicle comprising such a laser scanner according to claim 7.

According to the invention, the deflection mirror arrangement comprises multiple deflection mirrors, which are arranged in relation to one another such that each deflection mirror acquires a partial field of vision of the field of vision of the laser scanner. In this case, each deflection mirror is switchable by the control unit between an active mirror status, in which the respective deflection mirror reflects incoming light beams on the beam path, and a passive mirror status, in which incoming light beams in the beam path pass the deflection mirror. To scan the field of vision, the control unit alternatively activates the deflection mirrors, and therefore the deflection mirror which is in an active mirror status reflects the incoming light beam. In other words, the beam path between optical emitter and receiver is always conducted via a deflection mirror switched in the active mirror status as provided by the control unit.

The beam path to the optoelectronic receiver leads in this case via one of the switchable deflection mirrors in each case, and therefore by successive activation of the deflection mirrors, a field of vision can be scanned step-by-step in accordance with the sum of the partial fields of vision which can be acquired via individual deflection mirrors. In this manner, the laser scanner according to the invention acquires the entire field of vision without power consumption for a drive device for the deflection mirror arrangement, which is required in previous laser scanners. In addition to a significantly reduced power consumption, the heat production is also reduced in comparison to conventional laser scanners having drive motors for the deflection mirror arrangement. Furthermore, a laser scanner without electrical drive motor requires substantially less installation space.

In one advantageous embodiment of the invention, the deflection mirrors are arranged one over another in a mirror stack having at least partial overlap at intervals in the longitudinal direction of the mirror stack. All deflection mirrors are located in this case close to a longitudinal axis of the mirror stack formed by the deflection mirrors, and therefore each of the mirrors may cause incoming light beams to reflect or pass as needed. Those deflection mirrors which are located in the mirror stack closer to the entry of the incoming light beams in the mirror stack than the deflection mirror in the active mirror status are switched in this case into the passive mirror status.

Each of the deflection mirrors is arranged in the mirror stack with an inclination in relation to a longitudinal axis of the mirror stack, and therefore a deflection into the respective partial field of vision sector is ensured.

The deflection mirrors are advantageously electrically switchable between the active mirror status and the passive mirror status. In other words, the deflection mirrors are designed as electrically switchable transflectors and act as a reflector in the active mirror status. In the passive mirror status, the respective deflection mirror is transmissive to the incoming light beams in the beam path. The deflection mirrors are arranged in this case in the mirror stack one over another such that a region covered by all deflection mirrors is formed, in which the incoming light beam passes up to the deflection mirror switched into the active mirror status and up to that point is transmitted through the deflection mirrors in the passive status. In the embodiment of the deflection mirrors as transflectors, the mirror status is characterized by the transparency of the deflection mirror, namely either reflective in the active mirror status or transparent and/or transmissive to the incoming light beams in the passive mirror status.

In a further advantageous embodiment of the invention, the switchable deflection mirrors are designed as tilt elements, wherein the mirror status of the tiltable deflection mirrors is characterized by an active position, in which the deflection mirror is tilted into the beam path of the incoming light beams, and a passive mirror position, in which the deflection mirror lies outside the beam path.

If the deflection mirrors are arranged spaced apart in rotational angles with respect to the longitudinal direction of the mirror stack, each deflection mirror thus acquires a different sector, which defines its respective partial field of vision, in accordance with its rotational angle position. In this case, the partial fields of vision respectively acquired by the deflection mirrors advantageously adjoin one another or partially overlap one another, wherein an association with the respective partial field of vision takes place in the scope of the analysis of the reception signal of the optoelectronic receiver.

A compact construction of the laser scanner is provided if the deflection mirrors are grouped in a spiral shape with respect to the longitudinal direction of the mirror stack formed by the deflection mirrors.

Exemplary embodiments of the invention are explained in greater detail hereafter on the basis of the drawing. In the figures:

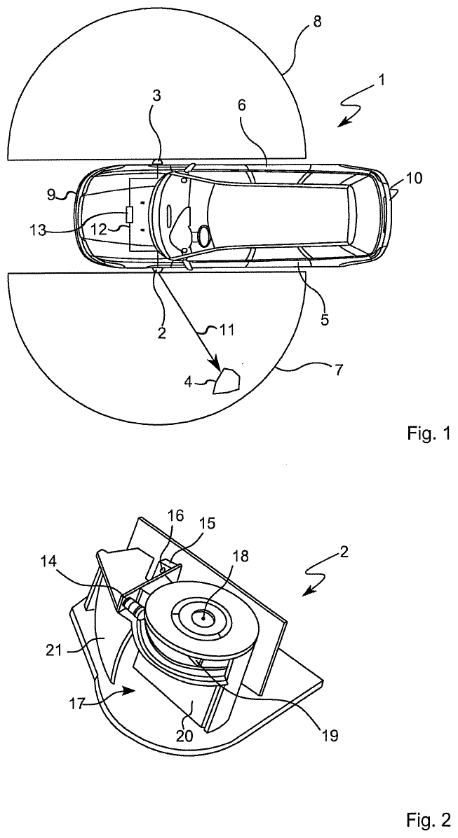

FIG. 1 shows a top view of a motor vehicle comprising a laser scanner,

FIG. 2 shows a perspective view of an exemplary embodiment of a laser scanner according to the prior art,

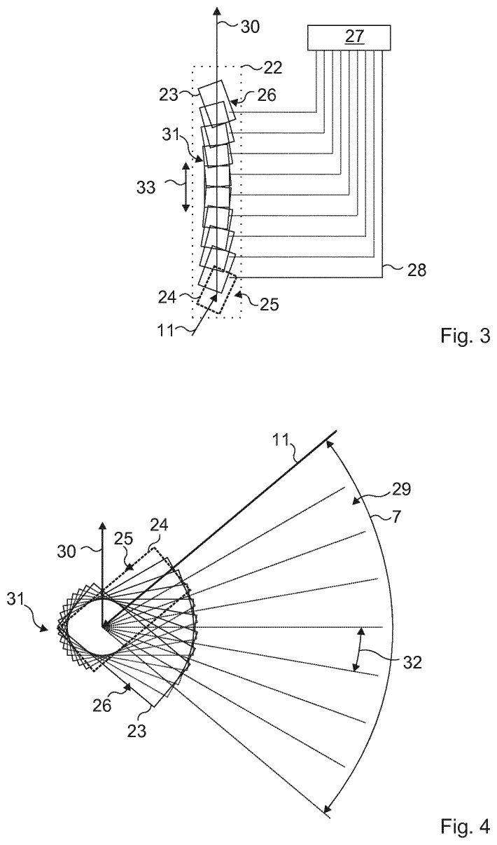

FIG. 3 shows a schematic illustration of an exemplary embodiment of a deflection mirror arrangement for a laser scanner,

FIG. 4 shows a top view of the deflection mirror arrangement according to FIG. 3.

FIG. 1 shows a top view of a motor vehicle 1 comprising two laser scanners 2, 3 in the exemplary embodiment for recognizing target objects 4 in the surroundings of the motor vehicle 1. The laser scanners 2, 3 are arranged in the exemplary embodiment shown on the sides 5, 6 of the motor vehicle 1. The laser scanners 2, 3 protrude in this case out of the vehicle body of the motor vehicle 1 and each acquire a lateral field of vision 7, 8.

Alternatively or additionally to the arrangement of laser scanners 2, 3 on the sides 5, 6 of the motor vehicle 1, laser scanners can be arranged at the front 9 or at the rear 10 of the motor vehicle 1.

The laser scanners 2, 3 each comprise at least one optical emitter 14 (see FIG. 2) for illuminating the surroundings of the laser scanner 2, 3, and an optoelectronic receiver 15 (FIG. 2). The optoelectronic receiver is designed to receive light beams 11 reflected at a target object 4 in the surroundings of the laser scanner 2, 3. The receiver provides an electrical reception signal 12 as a function of the received light beams. The electrical reception signal 12 or a detection result of an analysis of the reception signal 12 is provided to a driver assistance system 13 of the motor vehicle 1.

FIG. 2 shows a perspective view of a laser scanner 2 according to the prior art, as disclosed, for example, in DE 10 2010 047 984 A1. A housing of the laser scanner 2 is not shown in the illustration.

The laser scanner 2 comprises an optical emitter 14 embodied as a laser for emitting light beams 11 into the surroundings of the laser scanner 2. An optoelectronic receiver 15 is equipped with photodiodes 16, for example, avalanche diodes, which provide an electrical reception signal as a function of received light beams. The optical emitter 14 and the optoelectronic receiver 15 are adapted and calibrated to one another such that emitted light beams and received light beams can be associated with one another.

The laser scanner 2 according to the prior art comprises a deflection mirror arrangement 17, which is drivable by means of a drive unit (not shown) about an axis of rotation 18. The drive unit is often embodied as a stepping motor, and therefore a rotational angle position of the deflection mirror arrangement 17 can be associated with the measurement results of the laser scanner 2 and the field of vision can thus be sampled, i.e., scanned, step-by-step.

The deflection mirror arrangement 17 according to the prior art comprises multiple deflection mirrors 19, 20, which are associated with the optical emitter 14, on the one hand, and the receiver 15, on the other hand. A deflection mirror 19 is provided in this case as the emission mirror and is arranged at the height of the optical emitter 14. The light beams of the optical emitter 14 are deflected in accordance with the angle position of the deflection mirror 19 via this deflection mirror and guided onto the scene to be surveyed. The deflection mirror 20 is arranged as the reception mirror at the height of the receiver 15 and deflects the incoming light beams in the direction of the receiver 15. A receiving optical unit 21 is arranged between the optoelectronic receiver 15 and its deflection mirror 20. The deflection mirror arrangement 17 is connected to a control unit (not shown), which synchronizes the reception signals of the optoelectronic receiver 15 with the rotational angle position of the rotating deflection mirror arrangement 17 in operation of the laser scanner, in such a way that an item of information is provided about the orientation, and/or the direction of a detected object in relation to the laser scanner 2. The distance of a target object 4 (FIG. 1) results according to the principle of light runtime measurement.

FIG. 3 and FIG. 4 show a deflection mirror arrangement 22 of a laser scanner according to the invention. The laser scanner comprises optical emitters and optoelectronic receivers (not shown), which emit light (optical emitters) and receive reflected light beams (optoelectronic receivers) in a manner known per se and described on the basis of FIG. 2. Instead of the deflection mirror arrangement 17 driven in a rotating manner according to the prior art in FIG. 2, in the laser scanner according to the invention, a deflection mirror arrangement 22 described in greater detail hereafter is provided, the multiple deflection mirrors 23, 24 of which are electrically switchable between an active mirror status 25 and a passive mirror status 26 by a control unit 27. The deflection mirror arrangement 22 is arranged in the beam path 30 between the optical emitter 14 and the optoelectronic receiver 15, which are both not shown in FIG. 3.

The active mirror status 25 is symbolized in the illustration according to FIG. 3 by a dashed line at the deflection mirror 24. The further deflection mirrors 23 are each in the passive mirror status 26, which is symbolized by a solid line. In the active mirror status 25, the respective deflection mirror 24 reflects incoming light beams in the beam path 30. In the passive mirror status 26, incoming light beams pass the respective deflection mirrors 23. All deflection mirrors 23, 24 are switchable by the control unit 27 between the active mirror status 25 and the passive mirror status 26. In other words, all deflection mirrors 23, 24 are designed as transreflectors, which is to be understood to mean that the deflection mirrors reflect incident light beams 11 in the active mirror status 25 and are transparent in the passive switching status 26 and therefore are transmissive in the beam path 30. The deflection mirrors 23, 24 are alternatively switchable into the active mirror status 25 or the passive mirror status 26 as a function of a switching signal 28 of the control unit 27.

The deflection mirror arrangement 22 therefore determines the beam path 30, which always leads via a deflection mirror 24 in the active mirror status 25, via the switch setting of its deflection mirrors 23, 24. In the exemplary embodiment shown, the deflection mirror arrangement 22 deflects reflected light beams to the optoelectronic receiver. In a further exemplary embodiment (not shown), the deflection mirror arrangement 22 is associated with the optical emitter and deflects the light beams of the optical emitter onto the surroundings to be surveyed. The electrical switching signal 28 changes the optical properties of the transflector in this case.

The deflection mirrors 23, 24 are arranged arrayed one over another in a mirror stack 31. The deflection mirrors 23, 24 partially overlap in the stack direction 33 in this case, wherein the overlapping region is located in the region of the beam path 30 and is transparent in corresponding switch settings of the deflection mirror arrangement 22 in the case of the deflection mirrors 23 in the passive mirror status 26. The deflection mirrors 23, 24 are arranged spaced apart in this case at rotational angles 32 with respect to the stack direction 33 of the deflection mirrors 23, 24 in the mirror stack 31. The arrangement of the deflection mirrors 23, 24 offset in the rotational angle direction results in a relative position of the deflection mirrors 23, 24 such that each deflection mirror 23, 24 acquires a partial field of vision 33 of the field of vision 7 of the laser scanner. In this case, the deflection mirrors 23, 24 are located spaced apart from one another by equal rotational angles 32 in each case.

The deflection mirrors 23, 24 are located with an inclination in relation to the stack direction 33 of the mirror stack 31, and therefore the incident light beam 11 on a deflection mirror in the active mirror status 25 is deflected into the partial field of vision 29 associated with the respective deflection mirror 23, 24 or incoming light beams from the partial field of vision are deflected in the direction toward the optoelectronic receiver, respectively.

In operation of the laser scanner, the control unit 27 switches the deflection mirrors 23, 24 in succession into the active mirror status 25, and therefore light beams from the individual partial fields of vision 29 of the deflection mirror are received step-by-step and the entire field of vision 7 is scanned. Those deflection mirrors 23, which are closer to the entry of the incoming light beams 11 in the mirror stack 31 than the deflection mirror 24 presently switched into the active mirror status 25, are switched by the control unit 27 into the passive mirror status 26, and therefore they are transparent to the incident light beams in the provided beam path 30.

The deflection mirrors 23, 24 are configured and arranged spaced apart from one another by rotational angles 32 such that the partial fields of vision 33 which can respectively be acquired by the deflection mirrors 23, 24 (corresponding to the rotational angles 32) adjoin one another or partially overlap, and therefore a field of vision 7 which can be acquired continuously is provided. By way of the successive activation of the deflection mirrors 23, 24 by the control unit 27, the field of vision 7 can be scanned without a drive unit for the deflection mirrors and therefore with very low power consumption and heat development.

The deflection mirrors 23, 24 are grouped in a spiral shape with respect to the stack direction of the mirror stack 31, such that they are arranged with the desired inclination in relation to the longitudinal direction, on the one hand, and moreover at the desired rotational angle 32 (FIG. 4).

1. A laser scanner for a motor vehicle comprising:
an optical emitter for illuminating surroundings of the laser scanner, comprising an optoelectronic receiver for receiving light beams reflected at a target object in the surroundings of the laser scanner and for generating a reception signal corresponding to the received light beams;
a control unit; and
a deflection mirror arrangement, which is arranged in the region of a beam path of the light beams between optical emitter and optoelectronic receiver, and which is connected in a signal-transmitting manner to the control unit for the step-by-step scanning of a field of vision of the laser scanner in partial fields of vision,
wherein the deflection mirror arrangement comprises multiple deflection mirrors, which are arranged in relation to one another such that each deflection mirror acquires a partial field of vision of the laser scanner, wherein each deflection mirror is switchable by the control unit between an active mirror status, in which the respective deflection mirror reflects incoming light beams in the beam path, and a passive mirror status, in which incoming light beams in the beam path pass the respective deflection mirror.

2. A laser scanner according to claim 1, wherein the deflection mirrors are arranged one over another in a layer stack at intervals in the stack direction of the deflection mirrors in the mirror stack.

3. The laser scanner according to claim 1, wherein the deflection mirrors are electrically switchable between the active mirror status and the passive mirror status.

4. The laser scanner according to claim 1, wherein the deflection mirrors are arranged spaced apart at rotational angles with respect to the stack direction of the mirror stack.

5. The laser scanner according to claim 1, wherein the deflection mirrors are configured and arranged spaced apart from one another at rotational angles with respect to the stack direction of the mirror stack such that the partial fields of vision which can respectively be acquired by the deflection mirrors adjoin one another or partially overlap.

6. The laser scanner according to claim 1, wherein the deflection mirrors are grouped in a spiral shape with respect to the stack direction of the mirror stack.

7. A motor vehicle comprising a laser scanner according to claim 1.
